(19) United States
(12) Patent Application Publication
(10) Pub. No.: US 2014/0203103 A1
(43) Pub. Date: Jul. 24, 2014

(54) WATER BLASTING GUN SAFETY SYSTEM

(71) Applicant: PSC INDUSTRIAL OUTSOURCING, INC., Houston, TX (US)

(72) Inventor: Rick Pitman, Friendswood, TX (US)

(73) Assignee: PSC INDUSTRIAL OUTSOURCING, INC., Houston, TX (US)

(21) Appl. No.: 14/107,510

(22) Filed: Dec. 16, 2013

Related U.S. Application Data
(60) Provisional application No. 61/738,664, filed on Dec. 18, 2012.

(51) Int. Cl. B05B 15/00

(52) U.S. Cl. CPC B05B 15/00
USPC 239/71

(57) ABSTRACT

The invention relates to systems and methods for the safe operation of water blasting guns. The invention provides systems and methods for ensuring that a component of a water blasting gun can withstand the operating pressure of the gun. Aspects of the invention include a color-coding system for water blasting gun safety; tools for the proper assembly of a water blasting guns; gun components having a safety code; and computer systems for asset-tracking, job safety analysis, and instruction that promote the safe use of water blasting guns.

### CROSS-REFERENCE TO RELATED APPLICATION

This application claims the benefit of, and priority to, U.S. Provisional Patent Application Ser. No. 61/738,664, filed Dec. 18, 2012, the contents of which are incorporated by reference.

### FIELD OF THE INVENTION

The invention generally relates to high-pressure water blasting guns and to systems for the safe operation of water blasting guns.

### BACKGROUND

Water blasting guns can shoot streams of water at pressures up to 40,000 pounds per square inch. This makes them useful for such industrial jobs as oil field pipe cleaning, which requires that scale and gunk be blasted out of the pipes and tanks that are used in oil production.

These guns—sometimes called waterjet control guns, control guns, or shotguns—include both foot control guns, which are operated by activating a foot pedal and hand-operated control guns. These guns may be so-called dump guns, which release the pressure through opening a valve that discharges to atmosphere, or the shut-off style guns, which usually release pressure back to the supply side via an un-loader valve.

Using handheld guns to shoot streams of water at very high pressures carriers some safety risks. If a component of a gun fails while the water is at high pressure, the operator can be injured.

### SUMMARY

The invention provides systems and methods for ensuring that a component of a water blasting gun can withstand the operating pressure of the gun. Systems of the invention include components that are coordinated, so that an operator in the field uses the proper component in the gun that he or she is assembling. Further, the invention provides tools for assembling guns that make it easy to assemble the gun properly so that component failure is avoided. Additionally, the invention provides an asset-tracking system for water blasting guns and a Job Safety Analysis system for use of water blasting guns that encourage the use of the right component in a gun. The proper use of the proper component is also provided by a computer-based safety and information system that gives an organization tools for training operators throughout an organization, identifying components or batches of components that need to pulled from service, and initiating global-scale recalls of suspect components in ways that allow unsuitable components to be pulled from use within moments of identifying non-compliance or unsuitability. Since systems and methods of the invention encourage use of the proper components, encourage proper assembly of components, provide tools for implementing lessons learned by tracking job hazard incidents, and allow rapid and global-scale recall of non-compliant components, operators in the field will use water blasting guns that include only components suited for the intended use of the gun. Thus, components that are not rated for the intended pressures, components from recalled batches, or components past their end-of-life will not be used in water blasting operations. Since unsuitable components will not be used, component failure will be avoided, and thus serious injury will be minimized.

In some aspects, the invention provides a color-coding system for water blasting gun safety. Gun systems of the invention include a component for a first water blasting gun capable of withstanding a first pressure and comprising a first color and a component for a second water blasting gun capable of withstanding a second pressure and comprising a second color.

In certain aspects, the invention provides a tool that encourages the proper assembly of a water blasting gun in the form of a shadow mat that depicts the proper assembly of a gun. A shadow-mat device can include a sheet of material with printing in the form of substantially life-sized depictions of parts of a water blasting gun.

In other aspects, the invention provides a water blasting gun safety device in the form of a component for a water blasting gun system having a safety code visible on the component. The safety code can include, for example, a string of alphanumeric and special characters. In some embodiments, the string comprises a code that includes portions indicting location of use, manufacture date, asset number, manufacturer, pressure rating, other information, or a combination thereof. The code may appear on a hose fitting, for example, etched onto the hose fitting.

Aspects of the invention provide a water blasting gun safety system that employs a computer system with a tangible, non-transitory memory coupled to a processor in order to receive and store data identifying a component of a water blasting gun as well as service information about the component. The system can then provide a user with access to safety information for the component. The service information can include inspection data, maintenance data, testing data, other data, or a combination thereof.

In some embodiments, the system is used to generate a document that gives a compliance status relating to a compliance of the component with a safety standard.

In certain embodiments, the system is further operable to receive information about a safety hazard associated with the component and to be used for pulling other suspect components from service. The system can be operated to, based on the hazard information associated with the known component, identify a second component with a trait in common with the component (such as manufacturer, type, batch number, etc.). The system can then be used to provide a user, such as a user out in the field, with a notification that the second component is associated with the safety hazard.

### BRIEF DESCRIPTION OF THE DRAWINGS

FIG. 1 shows a water blasting gun safety system.

FIG. 2 shows a perspective view of water blasting gun.

FIG. 3 shows components of a water blasting gun.

FIG. 4 shows a shroud attached to a gun over a hose.

FIG. 5 shows a close-up view of a gun component with a visible indicia.

FIG. 6 shows hose ends of four different kinds of hoses.

FIG. 7 shows a shroud collar.

FIG. 8 shows a shadow mat for assembling a gun that is safe to use.

FIG. 9 shows a shadow mat for assembling a gun that is safe to use.

FIG. 10 shows a shadow mat for assembling a gun that is safe to use.

FIG. 11 shows a detailed portions of a shadow mat.

FIG. 12 shows a detailed portion of a shadow mat.

FIG. 13 shows a detailed portions of a shadow mat.

FIG. 14 gives a diagram of a computer system for water blasting gun safety.

FIG. 15 illustrates an electronic device of a safety system of the invention.

FIG. 16 shows a display of a device of a safety system.

FIG. 17 shows a display of a device of a safety system.

FIG. 18 shows a window displayed by a browser with safety information.

FIG. 19 shows a certificate of compliance as generated by a system of the invention.

FIG. 20 shows use of system to coordinate safety efforts.

### DETAILED DESCRIPTION

The invention provides systems and methods by which work that involves high pressure water blasting can be performed safely. In some embodiments, the invention provides common identification methods for hoses, fitting, tooling by pressure rating. Implementation of the invention provides an improved safety culture and program.

Using gun components as described herein, as well as shadow mats and JSA systems, job setup is standardize and equipment does not deviate from best practices or established procedures.

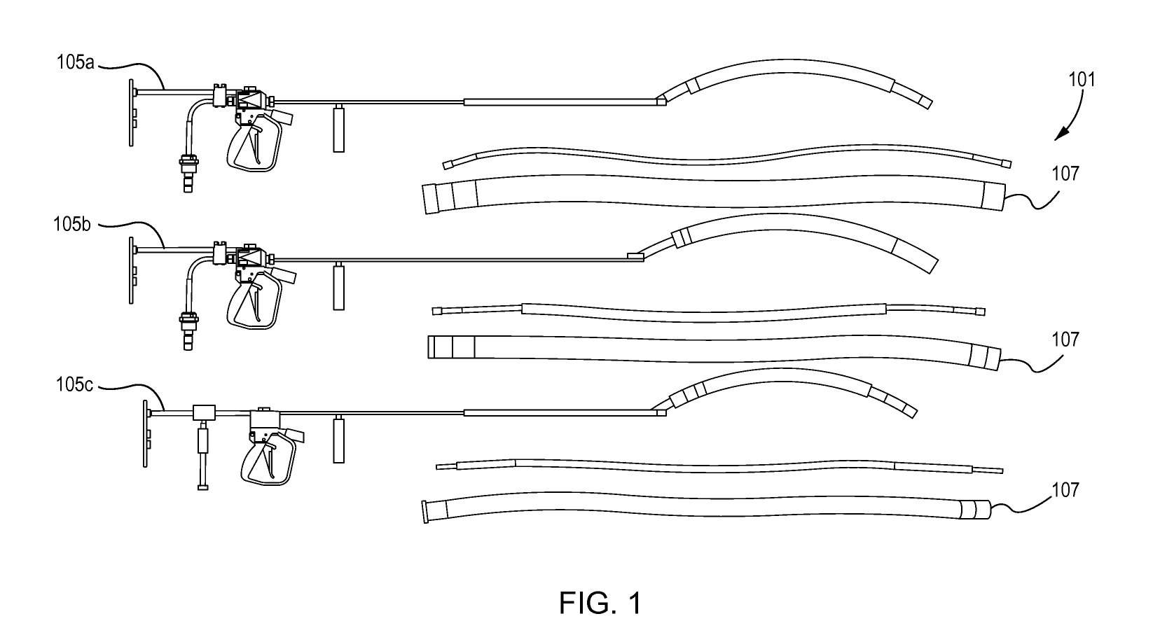

FIG. 1 shows a water blasting gun safety system. A safety system of the invention includes a plurality of guns 105, each manufactured to handle a different pressure of water, and a safety shroud for each gun. Each component of each gun, as well as its corresponding shroud, includes a surface that is color-coded so that assembling a gun and shroud from like-colored parts provides an assembled gun that is safe to operate at the intended pressure rating. The 40 k PSI gun 105a includes orange components. The 20 k PSI gun 105b includes blue components. The 10 k PSI gun 105c includes yellow components.

In some embodiments, each gun 105 is a dump gun. Dump guns are designed to minimize trigger pull while ensuring that the release of the trigger will quickly reduce the systems pressure to a minimum. Dump guns include a dump conduit for discharging water at low pressure from a dump conduit or nozzle when the high pressure water stream to the high pressure discharge nozzle is interrupted during use upon release of the manual trigger. Water blasting guns and related equipment are discussed in U.S. Pat. No. 5,975,429; U.S. Pat. No. 5,349,982; and U.S. Pat. No. 4,602,740, the contents of which are incorporated by reference. In some embodiments, the invention provides adequate standards for “High Pressure Systems”. In some embodiments, the invention provides systems and components configured to be sold in a form that do not allow for significant field modifications/deviations.

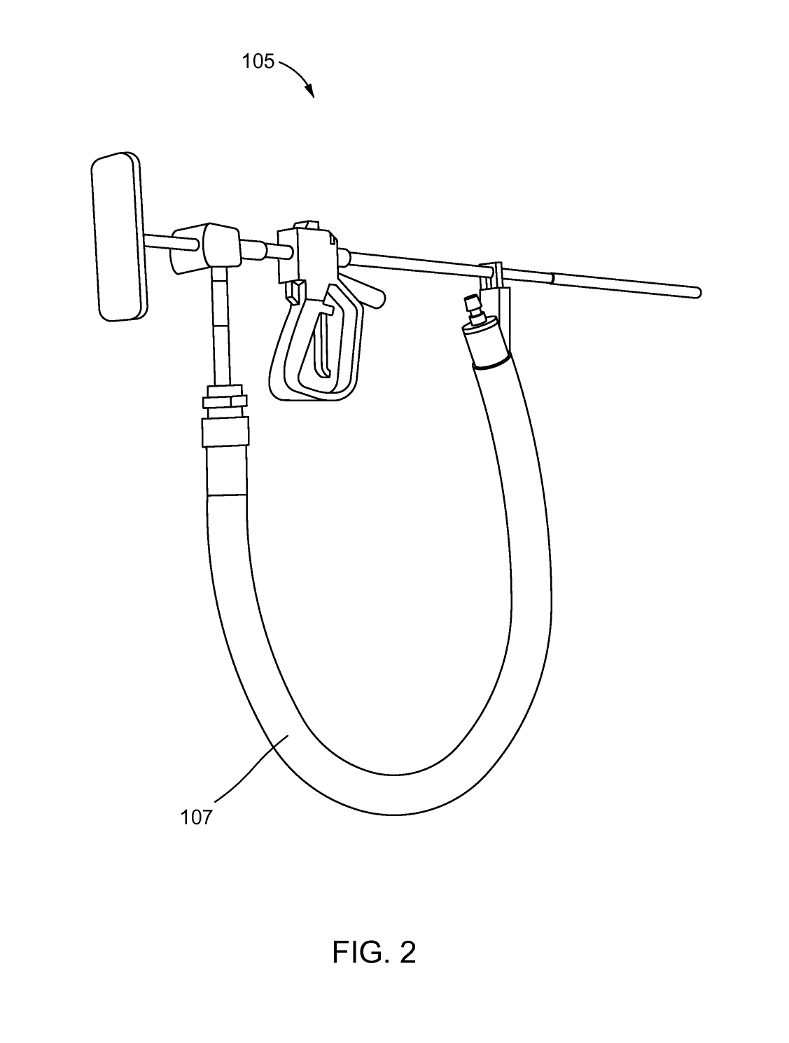

FIG. 2 shows a perspective view of water blasting gun 105. A shroud 107 covers the water supply hose to protect an operator in the event of failure of the hose.

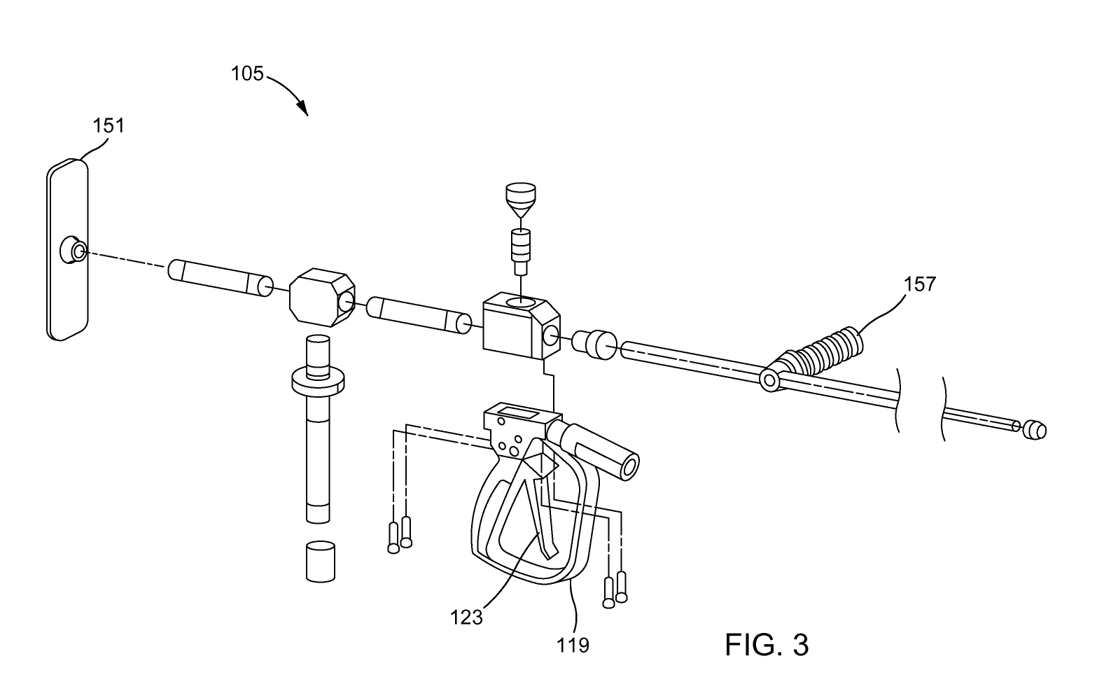

FIG. 3 shows components of a gun 105. Gun 105 includes tip 111 at a distal end of barrel 115. Trigger 123 is surrounded by trigger guard 119. Shoulder stock 151 extends from proximal end of gun 105. Mounted along barrel 115 is optional stabilizer handle 157. One safety feature that may be included is a minimum distance (e.g., 48″) from trigger 123 to tip 111 so that the water stream cannot contact any part of the person operating the gun. Mounted along barrel 115 is an optional stabilizer handle 157. Gun 105 further includes a guarded pressure-relief trigger, allowing an operator to control the pressure discharge.

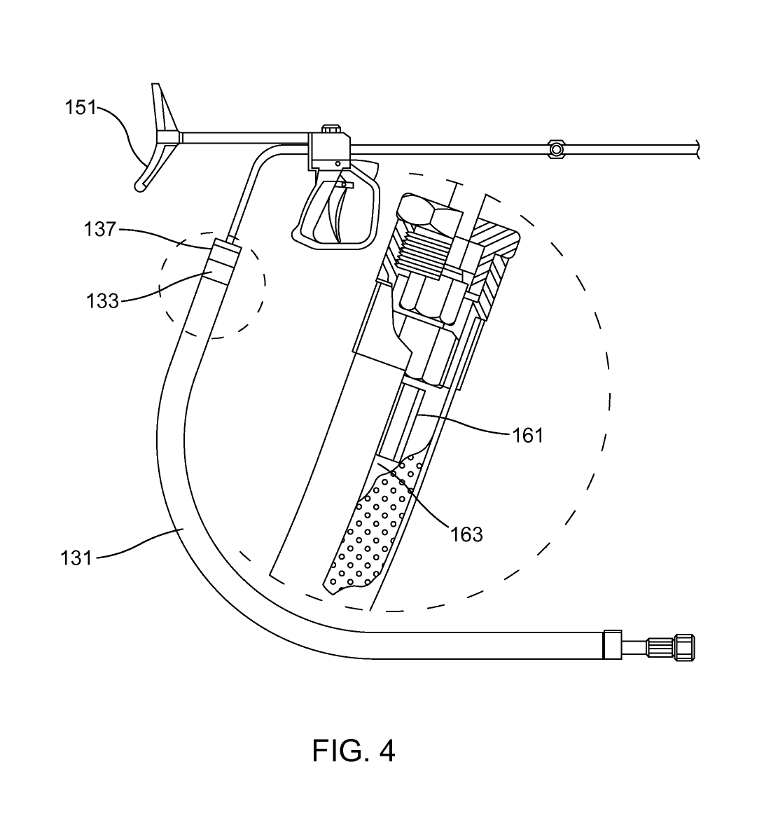

FIG. 4 shows shroud 131 attached to gun 105 over the hose. At a proximal end of shroud 131, shroud sleeve 133 extends to or into collar 137. Shroud 131 attaches to gun 105 over a connection between hose 163 and gun 105. Six-foot shroud 135 protects an operator of gun 105 in the event of hose failure. As seen in FIG. 4, inside of shroud 107, hose 163 connects to gun 105 via connector sleeve 161.

Gun 105 further may include a shoulder stock 151. Should stock 151 may include padding to ensure that an operator uses stock 151.

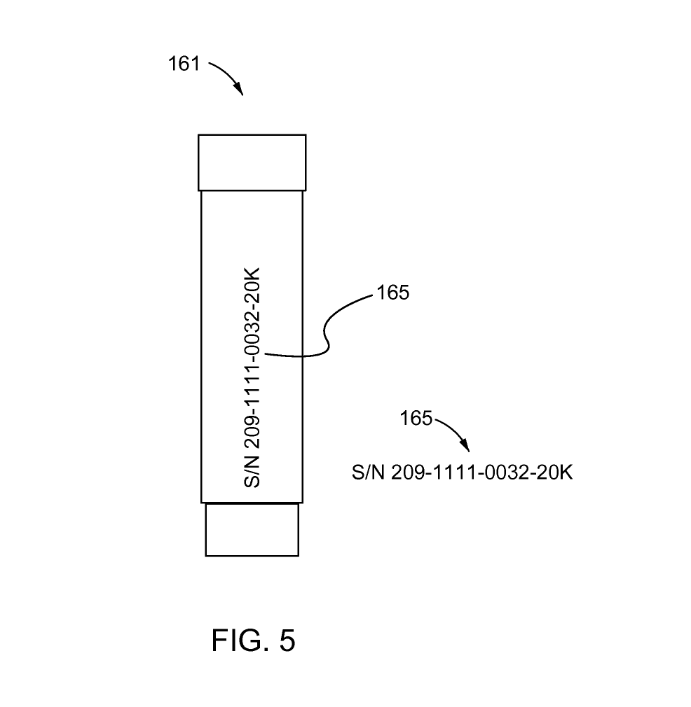

FIG. 5 shows a close-up view of connector sleeve 161 showing an indicia 165 visible thereupon. Here, the indicia is a character string, “S/N 209-1111-0032-20K”. Any suitable indicia 165 can be used, including character strings, icons, pictures, codes, barcodes, RFID tags, other, or a combination thereof. Preferably, indicia 165 includes portions that code for location of use, manufacturer, manufacture date, asset number, pressure rating, or a combination thereof. In certain embodiments, one feature of indicia 165 is that it is readable by an operator in the field. Indicia 165 can include common-sense formatting, such as a four-digit year of manufacture, or a plainly-stated pressure rating. Moreover, use of indicia 165 allows it to be grouped by manufacturer, asset number, type, site of use, etc., in an asset tracking system, discussed below.

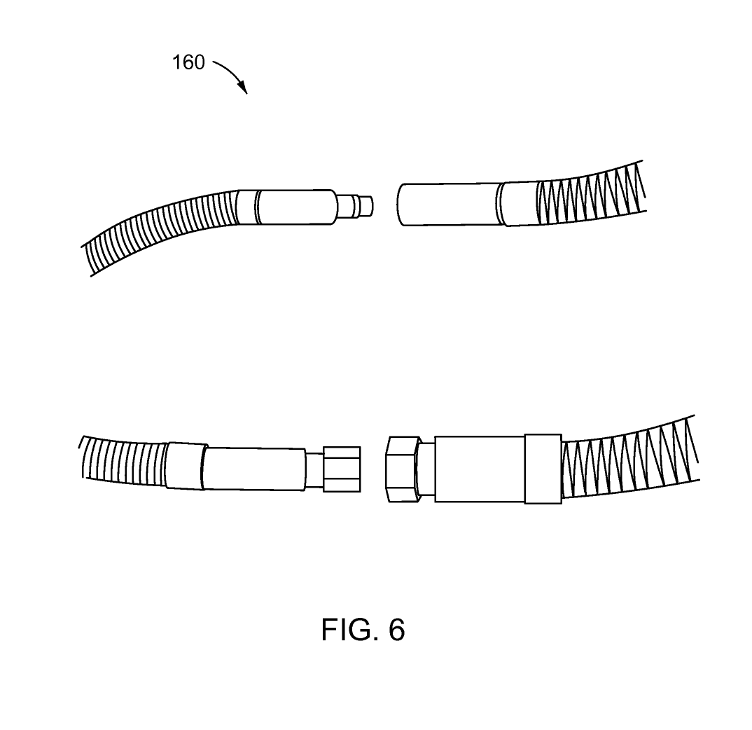

FIGS. 6A-6D show hose ends of four different kinds of hoses.

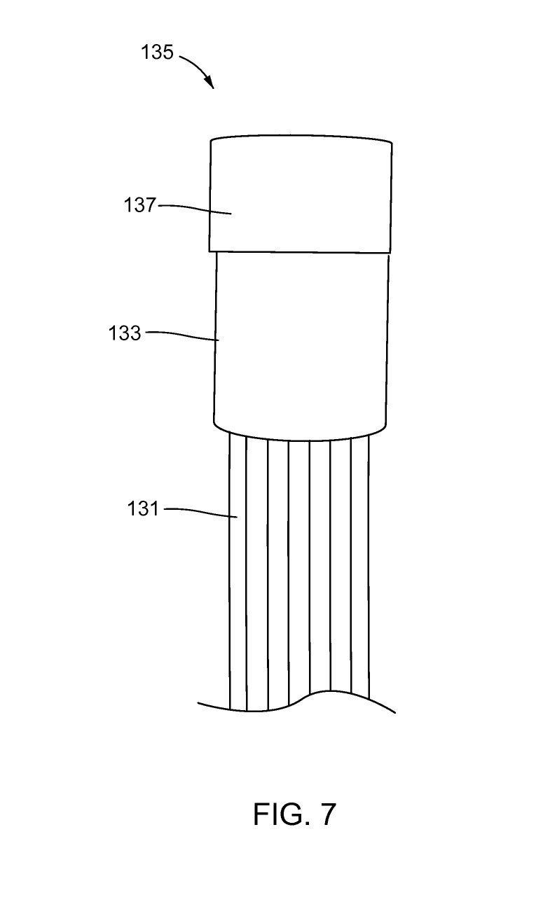

FIG. 7 shows a proximal end of shroud 131 with shroud sleeve 133 extending to collar 137. Shroud sleeve 133 protects a junction of shroud 131 with non-flexible hardware components, keeping the place where flexible material connects to non-flexible hardware from bending too steeply and fraying or breaking. Thus, shroud 131 maintains its ability to protect a worker from hose failure.

Using a gun 105 including components as described above, an operator has the hardware necessary to perform high pressure water blasting safely. Further, the invention provides tools for job setup that allow for job setup to be standardized, and to not deviate from best practices or established procedures.

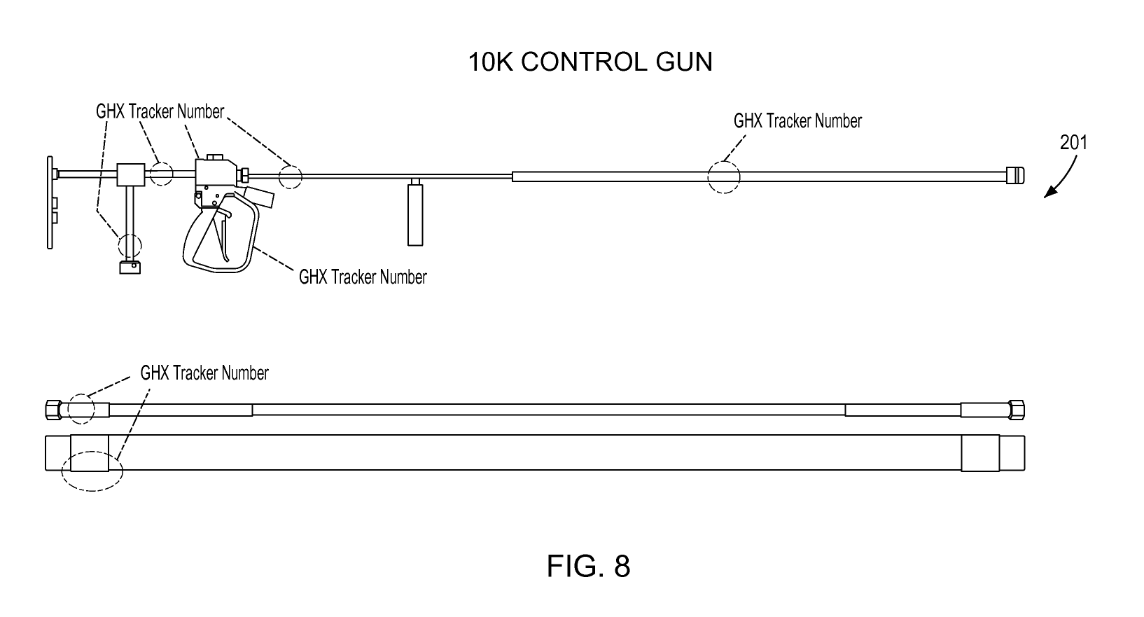

FIG. 8 shows a shadow mat 201. Here, shadow mat 201 is for a 10 k gun. A shadow mat 201 is provided as well as a procedure that uses shadow mat 201 to assemble a gun 105 that is safe to use at a desired pressure. Using shadow mat 201, an operator is provided with an intuitive and easy to follow tool to verify that he or she has each and every component for a gun 105 with the indicated pressure rating. If a given component does not fit on its shadow-print on mat 201, the operator can reject use of that component. Moreover, the mat 201 can have additional instructions and safety information printed thereon.

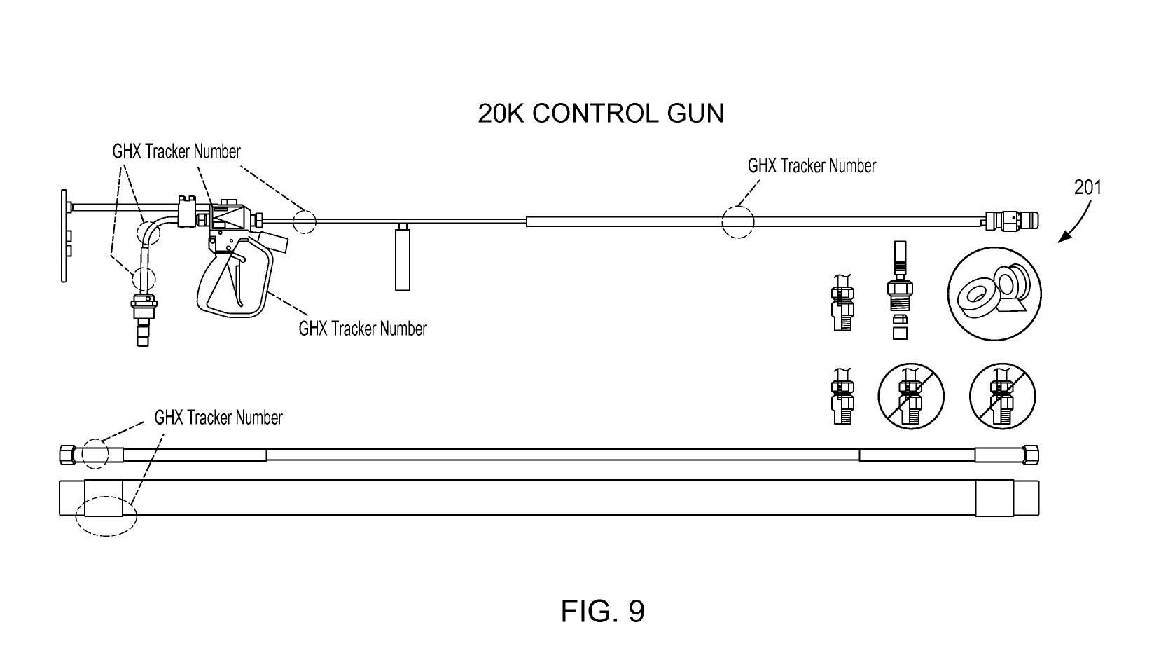

FIG. 9 shows a shadow mat 201 for a 20 k gun. In some embodiments, each gun of a certain pressure rating has its own shadow mat 201. Printing on mat 201 may be in color (e.g., components for the 10 k may be printed in color to match the actual components). Moreover, mat 201 may have different warnings printed to correspond with different pressure rating or different gun styles.

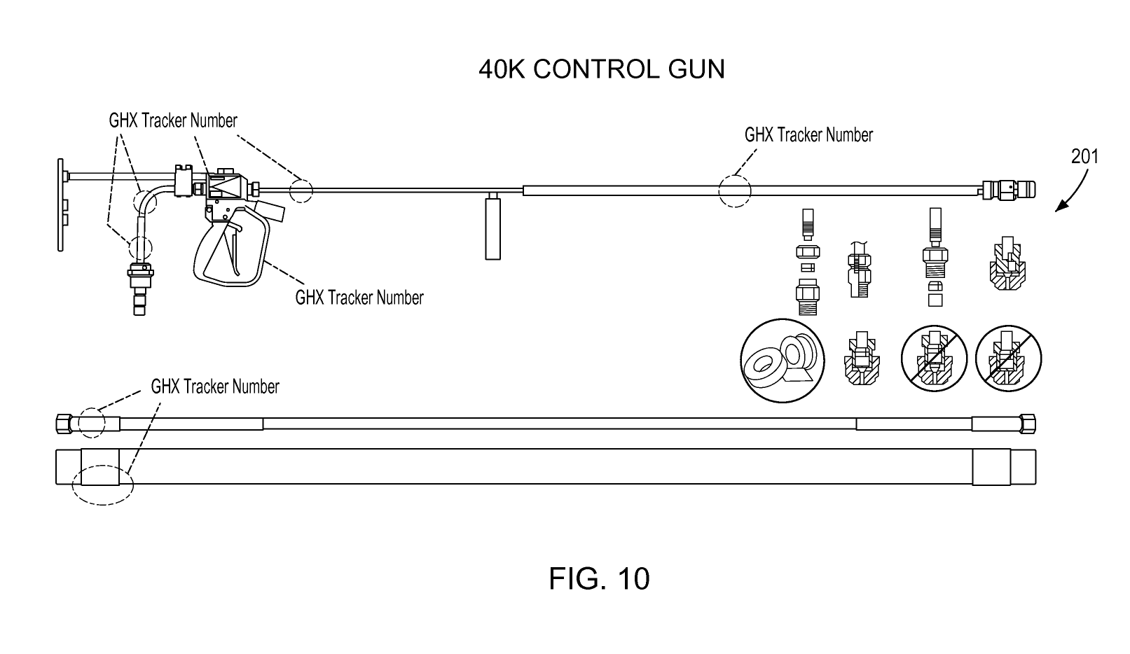

FIG. 10 shows a shadow mat for a 40 k gun.

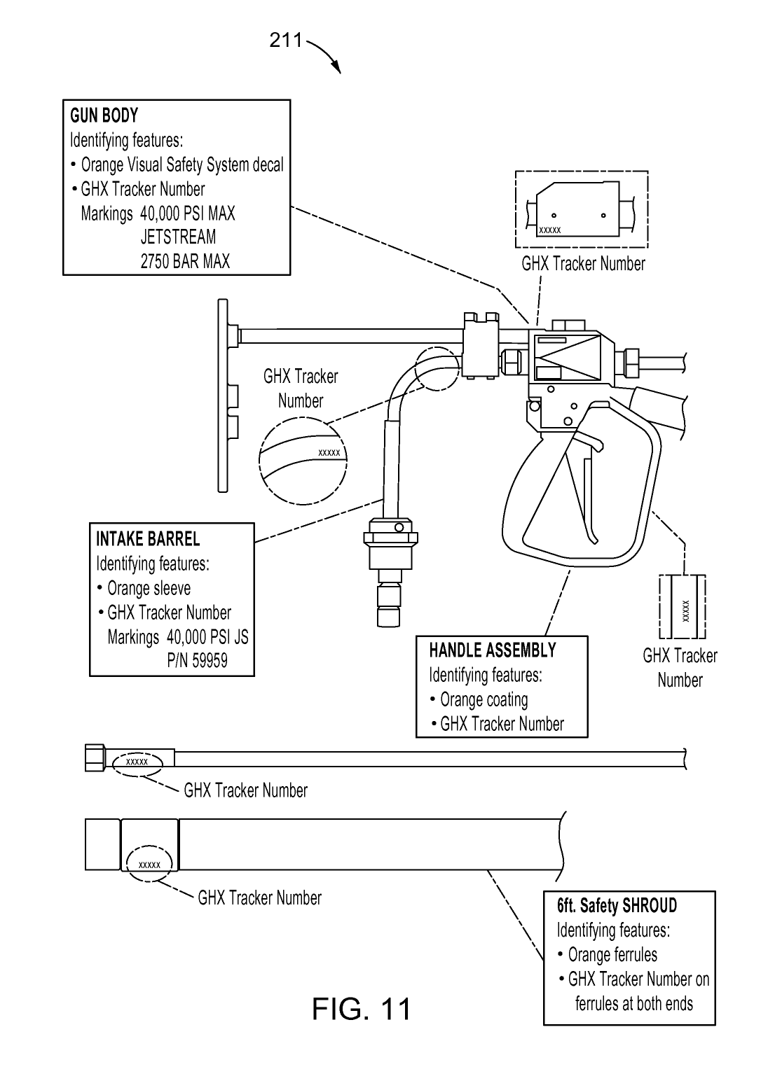

FIG. 11 shows a first matt portion 211 of a shadow matt 201. Detailed views of mat 201 show that each component of gun 105 can be presented with additional information. For example, by providing a reminder that each component shows an indicia that includes, for example, an asset-tracking system asset number, an operator can be reminded that the components can be looked up in the asset-tracking system. In this way, an operator may unroll shadow mat 201 to assemble a gun 105, be reminded to check an asset-tracking number, and look up the asset by number to discover that it is an end-of-life asset that needs to be taken out of service.

Noting that FIG. 11 shows an end of a hose and an end of a hose shroud, an operator may be reminded that components for use together need to bear appropriate asset tracking numbers. For example, if the indicia includes a code for pressure rating, an operator is reminded to ensure that those codes all match for a gun being assembled.

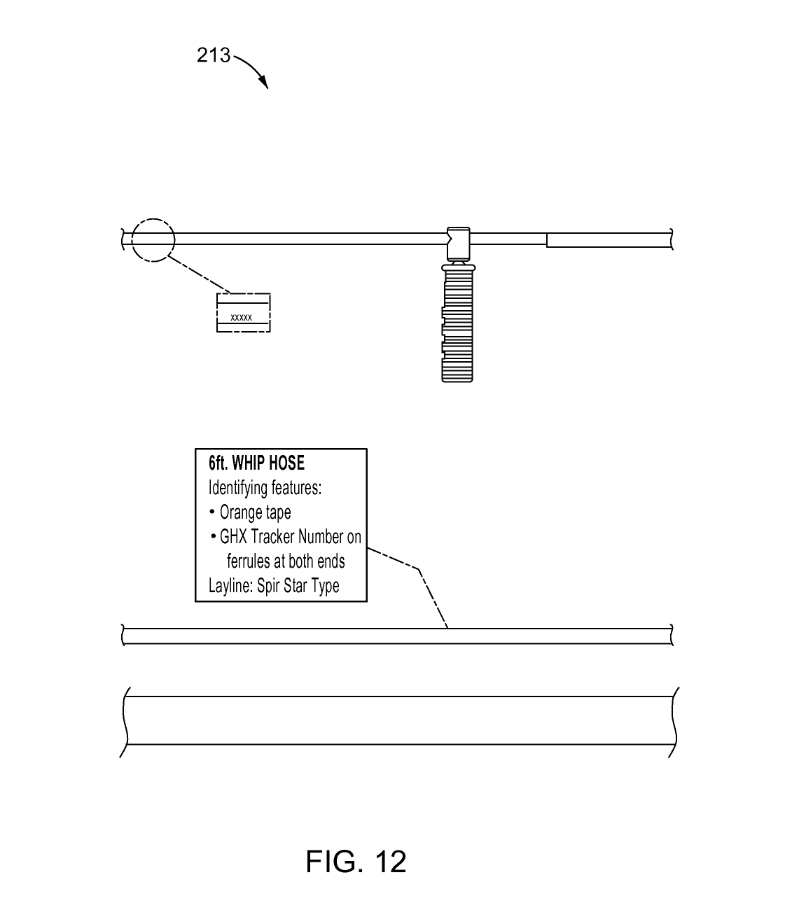

FIG. 12 shows a second matt portion 213 of a shadow matt 201. Note that shadow mat 201 may have assembly instructions or other safety information printed thereon.

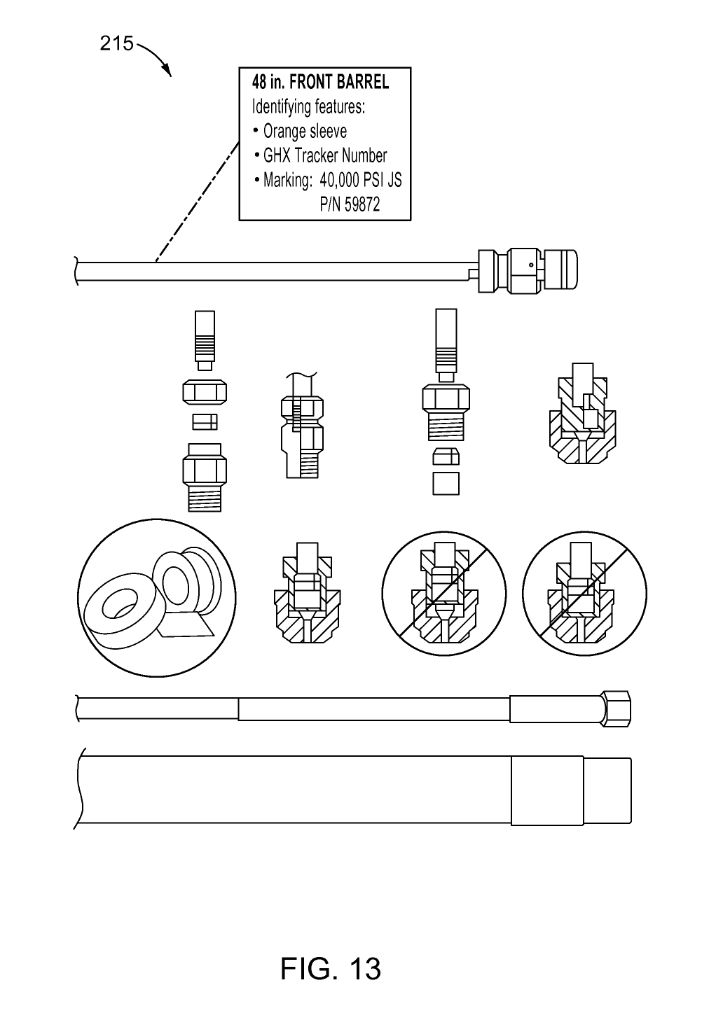

FIG. 13 shows a third matt portion 215 of a shadow matt 201. An assembly mat 201 may include one or more diagrams showing right or wrong ways to assemble components.

Safe operation of gun 105 can further be provided for through the use of an asset tracking system, a Job Safety Analysis (JSA) system, an instructional system, or system that performs a combination of those operations and related functionality. For example, an asset-tracking system can provide tools to standardize certification, maintenance, and inspection of components of system 101. A JSA system can provide tools for the timely recognition of a hazard such as, for example, the risk of operating a gun 105 without a shroud. JSA tools suitable for use with the invention are described in U.S. Pub. 2013/0179359 to Burns and in U.S. Pub. 2004/0078098 to Jeffries, the contents of each of which are incorporated by reference.

An instructional system can provide tools for training that include standardized curriculum and teaching methods. Curriculum and teaching methods can be provided that well-illustrate the basic elements of pressure systems and their maintenance and inspection requirements. Curriculum can be provided using a system that illustrates risks and consequences of procedures or non-compliance with those procedures. Asset-tracking, JSA tools, and curriculum can be provided that use language as used by operators in the field, and those tools and systems can be made “field available” through the use of, for example, ruggedized portable electronic devices. In some embodiments, the invention provides a “hydro-blasting certification” and a system that is able to track hours-in-craft and provide immediate notification and directives to personnel. In some embodiments, the invention provides systems and methods for a nationwide safety stand-down to communicate accident details. Using a system of the invention, an organization can implement a nationwide suspension of all hydro-blast shotgun work or a nationwide inventory review of all site hydro-blast equipment (e.g., hoses, guns, shrouds). Systems and methods of the invention may be used to inventory hundreds, thousands, tens of thousands, or more guns and components and reveal variation in shroud design, safety ratings, testing criteria and component compatibility. In some embodiments, the invention provides systems and methods for pressure testing of all hydro-blast hoses and components with a proof-of-testing record.

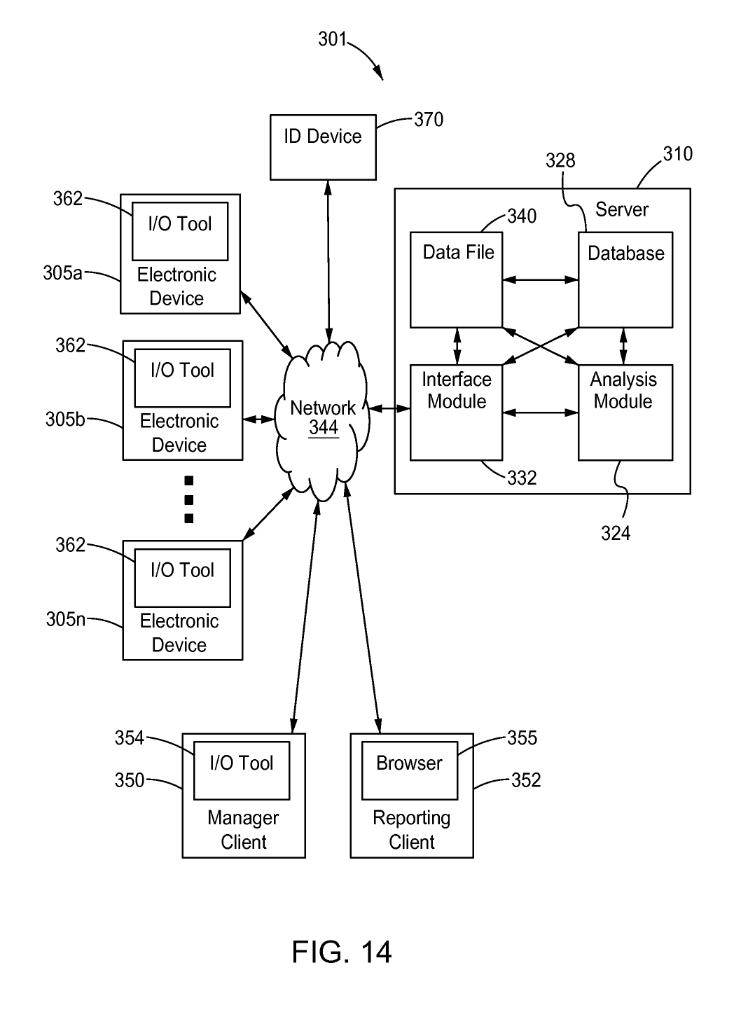

FIG. 14 gives a diagram of a computer system 301 for water blasting gun safety. Using the global information reach of system 301, an organization can implement safety tools and procedures as discussed above. For example, an organization could immediately change shroud policy to require a rating of 1.5× service pressure. Using the global information reach of system 301, an organization can provide enterprise-wide immediate notification to all operators of safety recommendations arising out of JSA review. As another example, an organization could use a system 301 to establish a life limit (e.g., 3 years) for all components (e.g., hoses) and initiate the replacement of all non-compliant hoses. With system 301, an organization can inspect, test and catalogue all gun components nationwide in a desired time frame. As a further illustrative example, using the global information reach of system 301, an organization can require that all hoses with proof of manufacture date less than two years be sent for inspection and that all hoses without proof of manufacture date, older than two years, or with visible braids be discarded.

In general, system 301 includes one or any number of electronic device 305 for use by an operator in the field. An operator share information through input/output tool 362. An input/output tool 362 could be a screen, touchscreen, keyboard, keypad, numeric keypad, power switch, microphone, speaker, camera, projector, light (e.g., LED), accelerometer, range-finder, bell, mouse, trackpad, pointing device, stylus, light pen, button, joystick, headphone jack, microphone jack, Ethernet port, USB port, Wi-Fi card, internet connection device, network card, cellular modem, cellular antenna, RF antenna, other device, or combination thereof. Electronic device 305 may be, for example, a computer, laptop, tablet, smartphone, custom device, cell phone, kiosk, or other electronic device. System 301 may include an identification device 370 such as a barcode reader or RFID tag reader, to allow for rapid inventory of components of system 101. System 301 may further include any of manager client 350, reporting client 352, or sever 310. Server 310, client 352, or client 350 may each be a computer, such as a rack-mounted server, a desktop computer, or a laptop computer or other device (e.g., tablet or other). Any of electronic device 305, server 310, client 352, or client 350 may generally include a memory operably coupled to a processer. In some embodiments, a processor is a general purpose microchip such as a computer processor made by Intel or AMD. A memory may include a disk drive, such as a magnetic drive like one made by Western Digital, or may be a solid-state memory drive (e.g., SSD or flash drive), an optical drive, a tape driver, other, or a combination thereof. In some embodiments, one or more of electronic device 305, server 310, client 352, or client 350 is a purpose-built device and includes, for example, an application-specific integrated circuit (ASIC), a field-programmable gate array (FPGA), a memory, a processor, or a combination thereof. Preferably, one or more of electronic device 305, server 310, client 352, and client 350 communicate with one another via network 344, which preferably includes networking hardware such as one or more of a cell tower, cell modem, internet cable, modem, Wi-Fi router, cable or DSL router, internet hub, switch, other, or a combination thereof. In some embodiments, one or more of electronic device 305, server 310, client 352, or client 350 will include a web browser (e.g., for browser 354 or browser 355), such as Internet Explorer, Firefox, or Chrome, for interaction with an asset tracking tool, JSA tool, instructional tool, or combination thereof. In certain embodiments, server 310 will include a database 328 for administering or storing information associated with an asset tracking tool, JSA tool, instructional tool, or combination thereof. Database 328 may read and write one or any number of data file 340 in a memory in server 310. Server 310 may moreover employ interface module 332 for data transfer, analysis module 324 to perform job safety analysis, or both. In related embodiments, data storage and administration take place not on a distinct server, but on one or more of electronic device 305, client 352, or client 350.

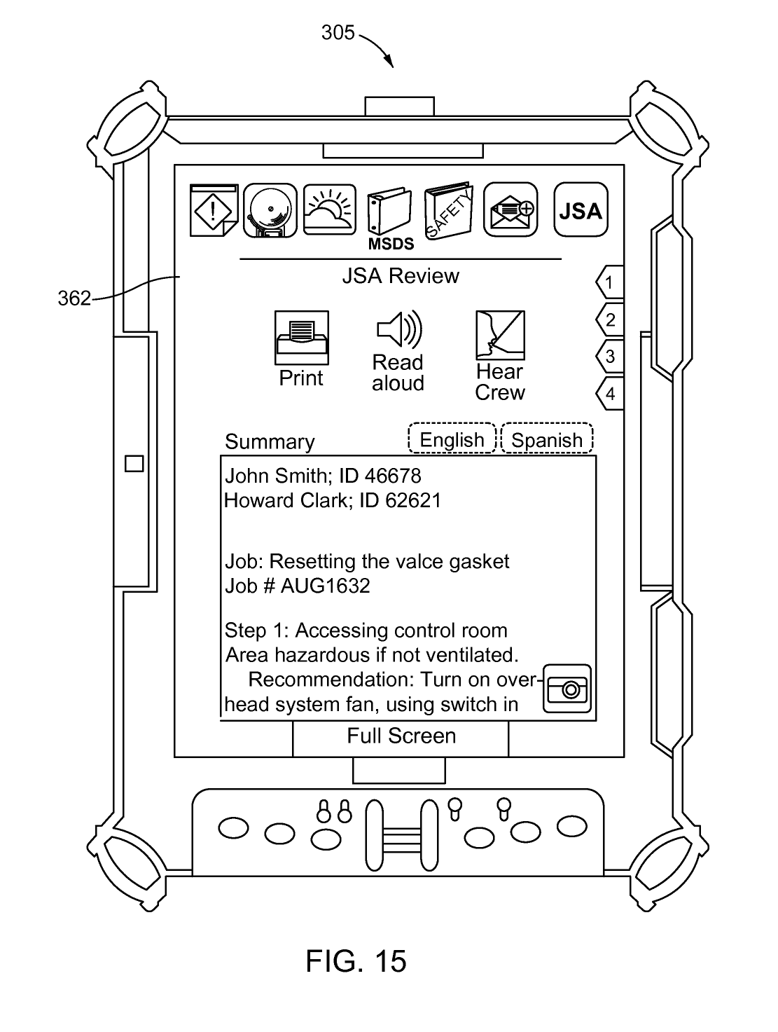

FIG. 15 illustrates an electronic device 305 having a touch screen as input-output tool 362. Device 305 may be used by an operator in the field to perform a step in a job safety analysis. Systems and methods for a Job Safety Analysis are described in co-pending application Ser. No. 13/402,343, filed on Feb. 22, 2012, and titled SYSTEM AND METHOD FOR JOB SAFETY ANALYSIS, the contents of which are incorporated by reference herein in their entirety.

In certain aspects, the invention provides a system for ensuring safety, the system including a portable electronic device 305 configured to capture information that identifies a job, operator, or water blasting gun and further including a data file, stored in the memory, containing information identifying a first step of a water-blasting job to be performed; an input tool 362 configured to capture hazard information associated with the first step of the job and store the hazard information in the data file; and an output mechanism operably engaged with the portable electronic device and configured to deliver a safety recommendation relating to the hazard. The input tool could be a touchscreen, microphone, camera, or other such as one of those listed above. Where system 301 includes server 310, server 310 may receive and save data from the data file and additional data from a second data file; and a computer processor operably engaged with the database and configured may analyze the saved data and the saved additional data and produce an output file including a hazard pattern.

The invention additionally provides any number of device 305, each configured to receive alert information and report the alert information to an operator. The alert may be relayed over network 344. A data file can be written to include information identifying the identity of a job to be performed, a step of a job to be performed, a second step of a job to be performed, a participant, a hazard, or a mitigation step for a hazard. A communication module can be used to send part of a data file from the portable electronic device to a second portable electronic device.

In certain embodiments, the computer processer or portable electronic device is further configured to provide a metric associated with the capturing of information by the portable electronic device. In certain embodiments, the metric includes one selected from the lists consisting of: a duration of a process; an identity of an operator; a size of a portion of the data file; a time of a computer interaction; a location of a computer interaction; information about a non-compliant component of gun 105; information about a water blasting job; other; or a combination thereof.

In some embodiments, the invention provides inspection and testing procedures that detect defects. For example, a supervisory personnel can use system 301 to prompt any or all operators in the field to inspect or test components of guns 105. In some embodiments, the invention provides tools for delivering information about hose inspection and testing procedures that identify or eliminate hose failures. Further, tools can provide visual inspection criteria that are not subjective or “experience based”. For example, a photo or diagram of a compromised component can be sent to device 305. More particularly, an operator in the field can take a measurement or a picture of a component of gun 105 and immediately share it with safety personnel or save it for documentation purposes.

In some embodiments, the invention provides systems and methods to track hose failures and to improve design or change work practices/procedures. For example, using a JSA screen on a device 305, an operator may input information about a hose failure, or information that leads to an improved design or work procedure.

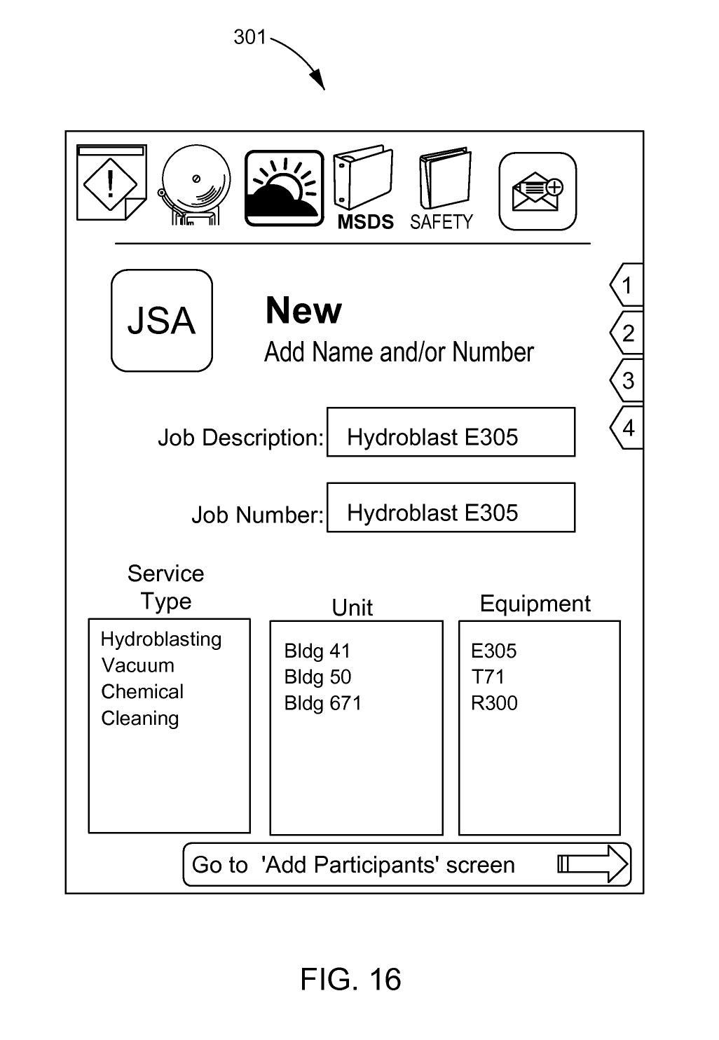

FIG. 16 shows a screen 362 of device 305 that may be used to conduct a JSA. Screen 362 as shown in FIG. 16 can be an input screen, an output screen, or both. For example, the service type field can be a list for the operator, or can be an input field to which an operator ads information.

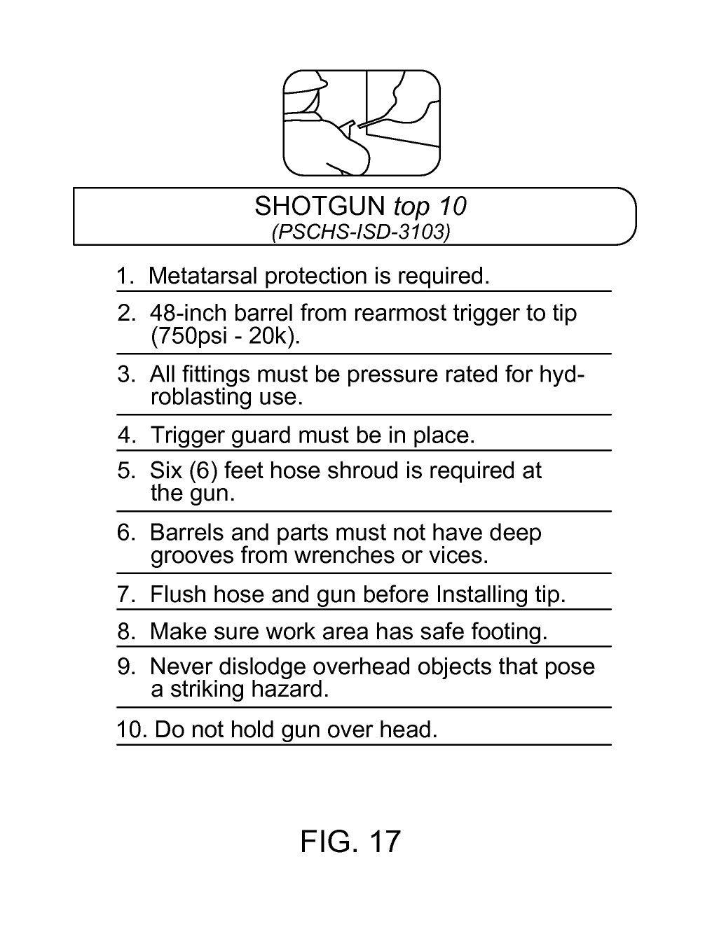

FIG. 17 shows a display that may be presented on a touch screen of input-output device 362. Safety information, such as the list shown in FIG. 17, may be presented to an operator when they begin assembling or operating gun 105. Safety information can be general and related to water blasting jobs or may be specific (for example, linked to an operator's use of a component from a specific manufacturer). Use of an asset-tracking system of the invention allows for component-specific safety information to be communicated and used in the field.

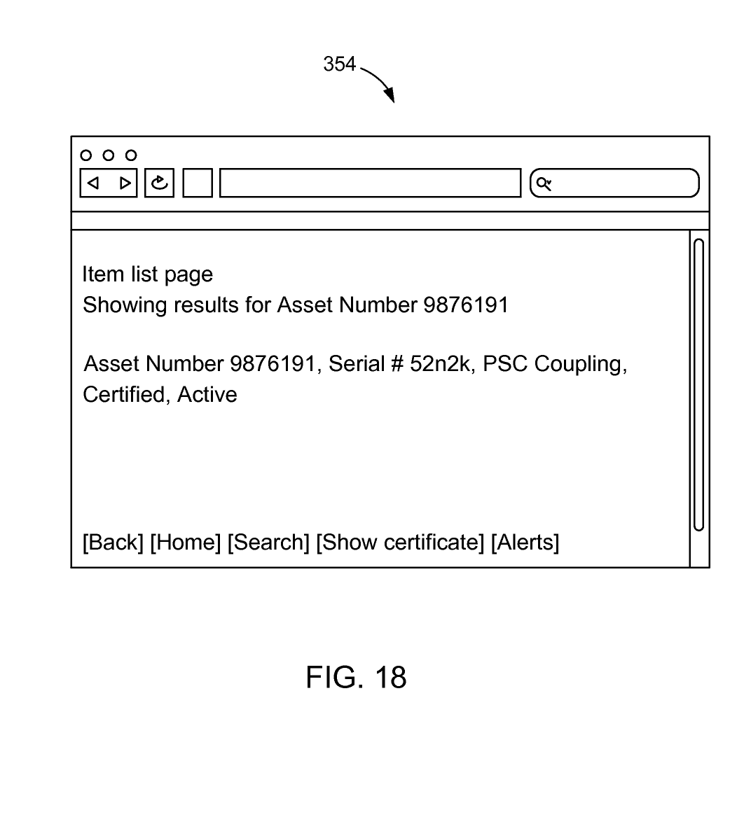

FIG. 18 shows a window displayed by a browser 354 (e.g., on manager client 350 or device 305). Browser 354 as shown in FIG. 18 displays a screen of an asset-tracking system according to certain embodiments. Each component can be tracked by asset number. Tracking permits components to be recalled, retired, or commented on specifically. Moreover, a category of components may be tracked. An asset-tracking system can be used to provide component safety ratings or installation guidance. For example, in some cases, manufacturers are inconsistent or silent on pressure ratings. Using a system of the invention, an organization can establish and share its own ratings or procedures; safety factors and testing protocol for component certification; or safety-oriented shotgun design. Where an organization's inventory of guns 105 includes guns 105 associated with different vendors and different system types (e.g., some guns with integrated shrouds and some guns that cannot accommodate a shroud), the organization can document and address this set of safety challenges in a coordinated fashion. In some embodiments, the invention provides a procurement process that can assist in controlling or enforcing safety compliance. Using asset-tracking, JSA, or instructional tools of the invention, an organization may: standardize field selection and assembly and avoid personal preferences or ad hoc shortcuts; implement standardized maintenance and inspection requirements; document safety related tools or incidents; establish procedures for vetting components of gun 105 for compliance; or issue certificates of compliance for components, guns, operator personnel, work sites, or divisions.

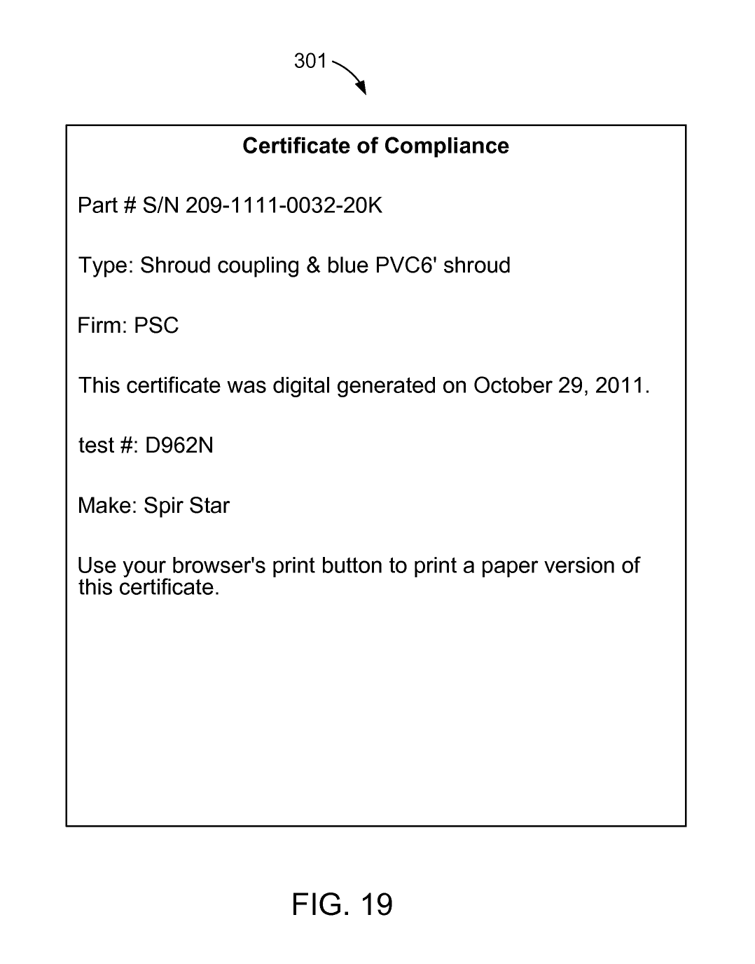

FIG. 19 shows a certificate of compliance 401. As shown in FIG. 19, certificate 401 indicates that a water blasting gun has been shown to comply with an organizations safety requirements. Such a certificate may be, for example, printed on paper and required to be provided along with a gun 105. In an alternative embodiments, certificate 401 is generated electronically and stored (e.g., as a data file 340) in system 301. Performing a water blasting operation can include the requirement that an operator access and verify the certificate of compliance (for example, by opening a PDF file version of the certificate for viewing on screen 362 of device 305.

In some embodiments, the invention provides systems and methods for verification of a reported capacity of a component of gun 105. For example, where a manufacturer prints 10K on a hose connector, representative components could be tested and non-complying batches could be removed from service. Or, for example, an organization could discard all existing shrouds nationwide due to lack of visible pressure rating on shroud.

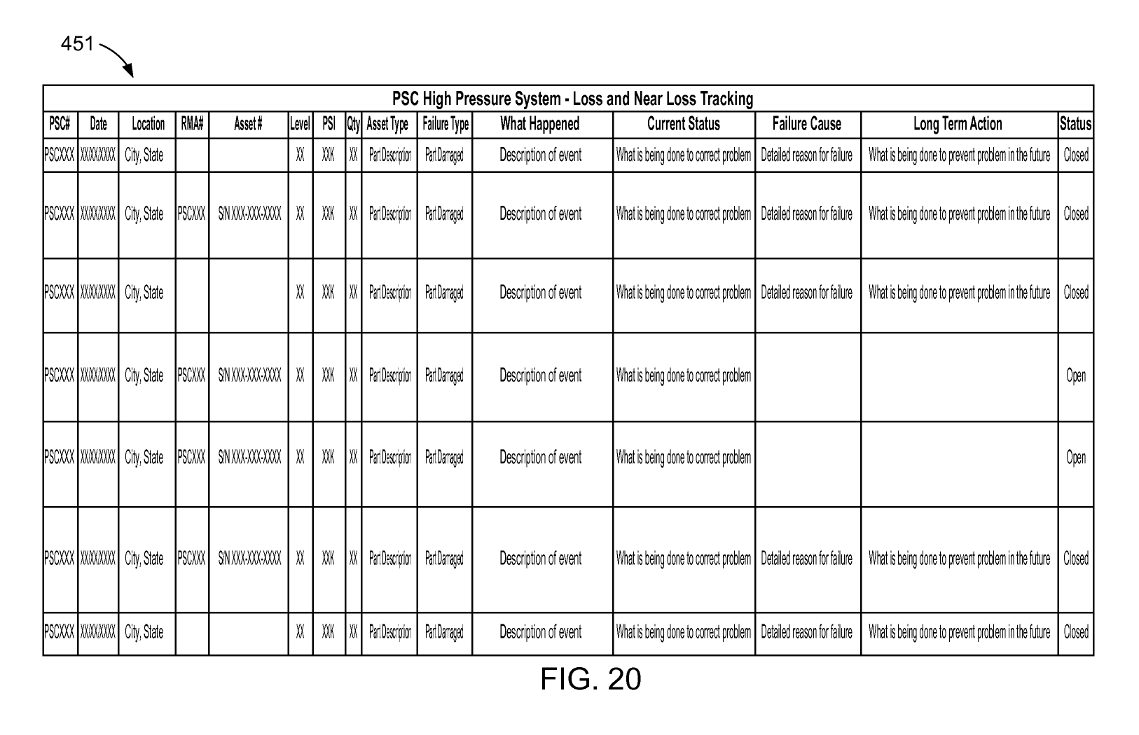

FIG. 20 shows use of system 301 to coordinate safety efforts. For example, system 301 allows same-day quarantine of other hoses manufactured in same lot number across the country. Failure at one location informs organization-wide safety efforts. In some embodiments, the invention provides systems and methods for centralized maintenance and inspection.

As discussed above, safety features can include: a pressure color added to components of guns and hoses; gun components fitted with colored abrasive cover to extend life and easily verify pressure rating; documentation that components are pressure tested; equipment records that are kept up-to-date in a system 301; and hazard incident documentation.

System 301 can be web-accessible to end users and may be used to track all inspection, maintenance, or testing data. System 301 can aid in standardizing components across an enterprise, field-training, in-field inventory of parts, procurement control, field-testing of prototypes, and storing actionable user feedback. Moreover, user feedback (e.g., collected from operators in the field via use of device 305) may be used to refine or improve aspects of system 301 or any other system or method discussed herein. Thus, for example, if a particular model of device 305 proves to be cumbersome and dis-liked by operators, they may record that fact on device 305, leading to replacing those devices that are more pleasurable to use, which may lead to better compliance with safety protocols, and result in safer water blasting operations. Materials suitable for use with the invention may be found described in U.S. Pat. No. 6,651,910; U.S. Pat. No. 5,305,919; U.S. Pat. No. 5,074,437; U.S. Pat. No. 4,593,858; U.S. Pat. No. 3,885,739; and U.S. Pat. No. 3,672,575, the contents of which are incorporated by reference.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A water blasting gun safety system comprising:
a first component for a first water blasting gun capable of withstanding a first pressure and comprising a first indicia;
a second component for the first water blasting gun comprising the first indicia;
a first component for a second water blasting gun capable of withstanding a second pressure and comprising a second indicia; and
a second component for the second water blasting gun comprising the second indicia.

2. The system of claim 1, further comprising:
a shadow-mat the guide assembly of a water gun, the mat comprising:
a sheet of material;
a surface on the sheet of material; and
printing comprising substantially life-sized depictions of parts of the water gun.

3. The system of claim 1, wherein each component comprises a safety code visible on the component.

4. The system of claim 3, wherein each safety code comprises a character string.

5. The system of claim 4, wherein each character string comprises a code for one selected from the list consisting of location; manufacture date; asset number; and pressure rating.

6. The system of claim 5, wherein the first and second indicia comprise different colors.

7. The system of claim 4, further comprising a computer comprising a non-transitory memory coupled to a processor operable to cause the computer to:
receive data identifying each component;
receive and store service information about each component; and
provide a user with access to safety information for each component.

8. The system of claim 7, wherein the service information includes one selected from the list consisting of inspection data, maintenance data, and testing data.

9. The system of claim 7, further operable to generate a document comprising a compliance status relating to a compliance of each component with a safety standard.

10. The system of claim 7, further operable to:
receive information about a safety hazard associated with a suspect component;
identify other a related component with a trait in common with the suspect component;
provide a user with a notification that the related component is associated with the safety hazard.

11. The system of claim 10, wherein each component is selected from the list consisting of shroud, water supply hose, barrel, trigger guard, shoulder stock, and stabilizer handle.
